(19) United States
(12) Patent Application Publication
(10) Pub. No.: US 2002/0116281 A1
(43) Pub. Date: Aug. 22, 2002

(54) Internet-based systems and methods for reallocating and selling used industrial equipment and machinery

(76) Inventors: Thomas Costello, West Chester, PA (US); Robert Yayac, Chadds Ford, PA (US); Brian Bradley, Wayne, PA (US)

Correspondence Address: Woodcock Washburn Kurtz, Mackiewicz & Norris LLp, 46th Floor, One Litberty Place, Philadelphia, PA, 19103, US

(21) Appl. No.: 09/847,923

(22) Filed: May 2, 2001

Related U.S. Application Data
(60) Provisional application No. 60/201,191, filed on May 2, 2000.

(51) Int. Cl. G06F 17/60

(52) U.S. Cl. 705/26

(57) ABSTRACT

A service accessible via a network, such as the Internet, provides a fully integrated asset management system for used industrial equipment and machinery. The service provides redeployment methods and systems linking groups and divisions locally or globally so as to provide for the internal reallocation of such equipment and machinery. The service also provides redistribution methods and systems for the external reallocation via direct sales and auctions.

### CROSS REFERENCE TO RELATED APPLICATION

This application is entitled to the benefit of the filing date of U.S. Provisional Application Ser. No. 60/201,191, filed on May 2, 2000.

### FIELD OF THE INVENTION

The present invention relates generally to the field of e-commerce, and more particularly to a system and method for reallocating and selling used industrial machinery and equipment over a network, such as the Internet.

### BACKGROUND OF THE INVENTION

E-commerce has rapidly become one of the most revolutionary activities to ever influence national and international economies. While e-commerce has presented itself in a variety of forms, business to business e-commerce has become especially important. The growth in the number of businesses using computers connected to the Internet has been tremendous, dramatically changing the way traditional business activities are conducted. Businesses are now able to sell their goods and services as well as purchase their own supplies and inventory on-line. Businesses can perform real-time market research, administer retirement plans and even hire employees on-line. As a result, business to business e-commerce is projected to soar from $43 billion in 1998 to over $1 trillion by 2003.

The buying and selling of used industrial equipment and machinery has rapidly become an important on-line activity. Although this market has huge potential, manufacturing firms have found it extremely difficult to buy and sell used equipment and machinery over the Internet. The used equipment and machinery marketplace is a large, fragmented market characterized by large margins and poor information flow, and thus is extremely inefficient. Large capital and infrastructure requirements have prevented existing market participants from broadening their participation in the market, as well as the entry of new participants. Market participants have thus been unable to gain significant market share. As a result, the market has been characterized by many small market participants, each with specific expertise in a particular asset class or industrial application. Mistrust has developed between these market participants as well as between buyers and sellers of used industrial equipment and machinery. Additionally, the small market participants typically have limited professional management skills, and thus are typically unable to implement efficient business processes. As a result of inefficiencies in the market, many intermediate middlemen and transactions have developed between sellers and buyers.

Such markets, however, are ideally suited to benefit from the advantages provided by the Internet. Indeed, the growth of business to business e-commerce can be at least partially explained by the tremendous efficiencies brought to such markets. It is expected that by dramatically increasing information flow, the introduction of the Internet can have dramatic effects for both buyers and sellers in the used industrial equipment and machinery market. While this will be especially threatening to those market participants whose only value is their local or unique information, market participants that embrace this technology can quickly benefit. For example, the Internet can provide a platform for sellers to quickly build scale cost effectively, a major cause of market fragmentation. A market participant's access to capital can increase as a result of the Internet's ability to facilitate quick growth. In sum, the Internet's ability to increase access to information, capital and infrastructure and provide for improved business processes can allow a market participant to become the primary means of servicing the used industrial equipment and machinery marketplace.

Several businesses, including Internet-based businesses, have identified this market and its poor flow of information. Most have attempted to address the inefficiencies of this market by offering Internet exchanges or buyer/seller listing services similar to an on-line auction house (ebay.com, for example). Some businesses (e.g., Dovebid.com) have attempted to combine their existing asset recovery and auction experience with an Internet presence. Other Web-only auction firms (e.g., Tradeout.com, iMark.com and BizSurplus.com) have attempted to provide buyer and seller matching services. Industry specific auction sites have also appeared (including MedMarketAuction.com and LabX.com), as well as firm specific sites (e.g., Campbell Soup's campbells-equipment.com). Retail/consumer sites and industry market makers include ebay, ubid and auctionnet.com. Other Internet firms such as Freemarket and I2I focus on the auction of technology. While most of these Internet business models simply list surplus assets for sale, assuming buyers will come to transact business, others business models have attempted to attract sellers by listing buyers.

Although these types of exchanges have worked well in commodity type markets where the products are standard and well known, they have not worked well in the used industrial equipment and machinery market. This can be explained by the failure of existing business models to address the issues that are key for successful transactions to occur in this market. While the primary advantage of most existing business models are lower prices for buyers and increased access to buyers for sellers, in most business to business markets, price is usually not the most critical factor. In the used industrial equipment and machinery market, both buyers and sellers are concerned primarily with certain assurances rather than pricing. Because the condition of used assets may range from brand new to almost scrap, buyers need assurances that the asset being purchased exists in the condition specified. Such assurances can take many forms, including asset inspections, appraisals and warranties. Sellers also need assurances that buyers are qualified and capable of closing transactions due to the large amounts of capital involved. Existing business models do not considered these issues.

Existing business models also fail to consider that mainstream markets are reluctant to embrace online technology and typically look to current relationships to assist in the transition to new technology models. Thus, although existing Internet exchanges have attracted some early technology adopters, they have not been able to significantly penetrate the mainstream market. This can be attributed to several factors. Participants in the used industrial equipment and machinery marketplace, for example, are comfortable with their current relationships and are not trusting of newcomers. Customers in this market are extremely loyal and thus managing customer relationships is critical in repelling aggressive customer acquisition strategies by new entries. Existing Internet business models have been unable to address such concerns, and so there has been a limited use of existing Internet exchanges for buying and selling used industrial equipment and machinery. Indeed, the majority of these exchanges have been returning to handling commodity items and surplus inventory. However, the characteristics of this market still suggest that firms with traditional off-line services and existing relationships can leverage these capabilities to more easily take advantage of on-line business models.

Existing on-line and Internet-based business models have also failed to take advantage of those internal opportunities presented by participants in the used industrial equipment and machinery marketplace. For instance, many of the participants in this market are large industrial concerns having many divisions or corporate sites (e.g., manufacturing, inventory and distribution) with large numbers and types of assets and inventory. A particular division or corporate site may no longer be able to utilize a particular asset, while another division or corporate site may have a current use for that asset. For example, while consumers may no longer be interested in an electrical motor currently part of inventory, manufacturing may be able to utilize the motor in their own operations. Internal redeployment (the transfer of assets between divisions or corporate sites of the industrial concern) can be greatly facilitated through the use of on-line, or networking, technology. Moreover, by using on-line technology to integrate an internal redeployment capability with external buyers, the inefficiencies of the used industrial equipment and machinery marketplace can be further reduced. No existing business model presents such an opportunity.

The foregoing discussion makes it clear that there is a need for a network-based, on-line, business to business service that can act as a market maker between buyers and sellers of used industrial equipment and machinery. In addition, there is a need for an on-line service that not only provides price value but also both transaction value and transaction volume. Further, there is a need for an on-line service that provides for the internal reallocation of assets.

### SUMMARY OF THE INVENTION

The present invention is generally directed to a service accessible via a network, such as the Internet, for providing a fully integrated asset management system for used industrial equipment and machinery. The service provides redeployment methods and systems linking groups and divisions locally or globally so as to provide for the internal reallocation of used industrial equipment and machinery. The service also provides redistribution methods and systems for the external reallocation via direct sales and auctions of used industrial equipment and machinery. In sum, the methods and systems of the present invention provide for a comprehensive asset and database management system for participants in the used industrial equipment and machinery marketplace. Other aspects of the present invention are described below.

### BRIEF DESCRIPTION OF THE DRAWINGS

The foregoing summary as well as the following detailed description of preferred embodiments are better understood when read in conjunction with the appended drawings. In the drawings:

FIG. 1 is a schematic diagram of a computer network in which aspects of the present invention may be incorporated.

FIG. 2 is another schematic diagram of a computer network in which aspects of the present invention may be incorporated.

FIG. 3 is a diagram representing an overview of the present invention in accordance with preferred embodiments of the invention.

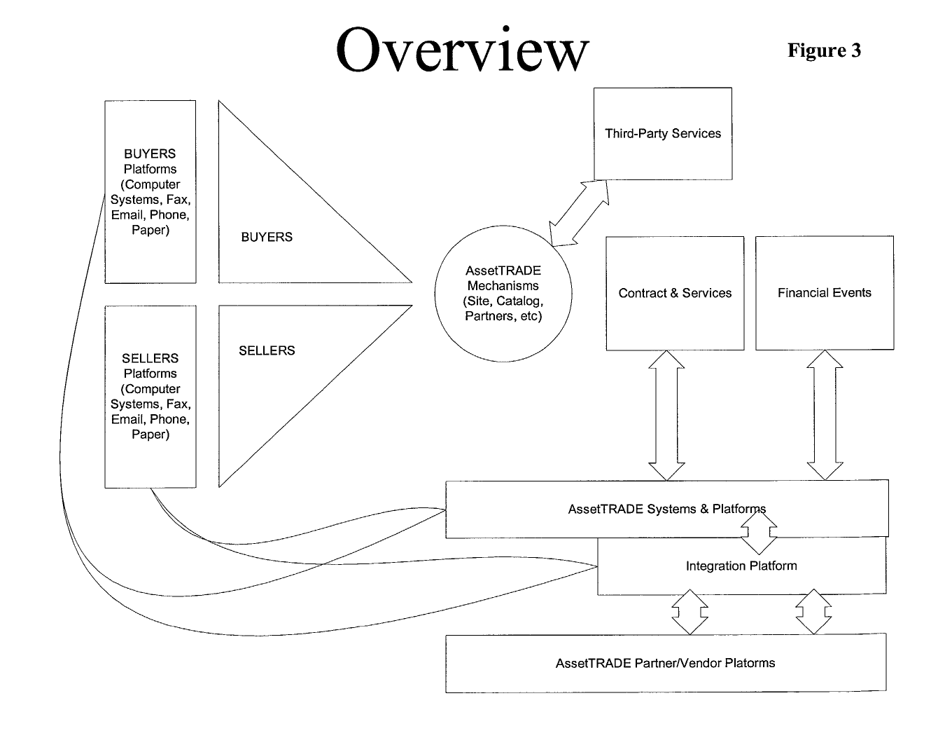

FIG. 4 is a diagram representing assets and inventory in accordance with preferred embodiments of the invention.

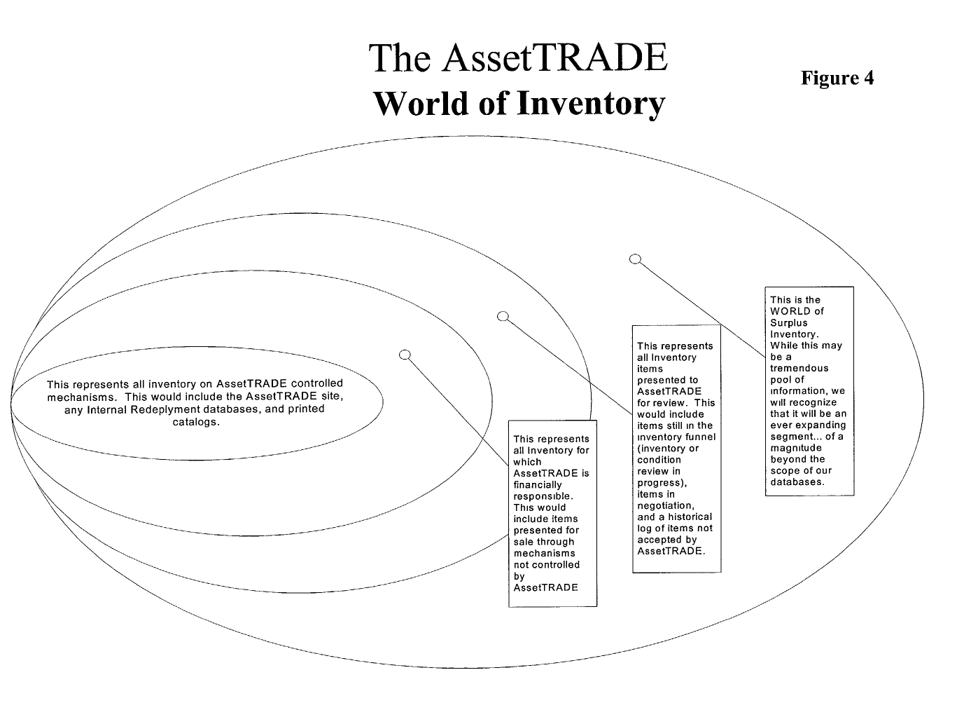

FIG. 5 is a diagram representing data and information regarding assets and inventory in accordance with preferred embodiments of the invention.

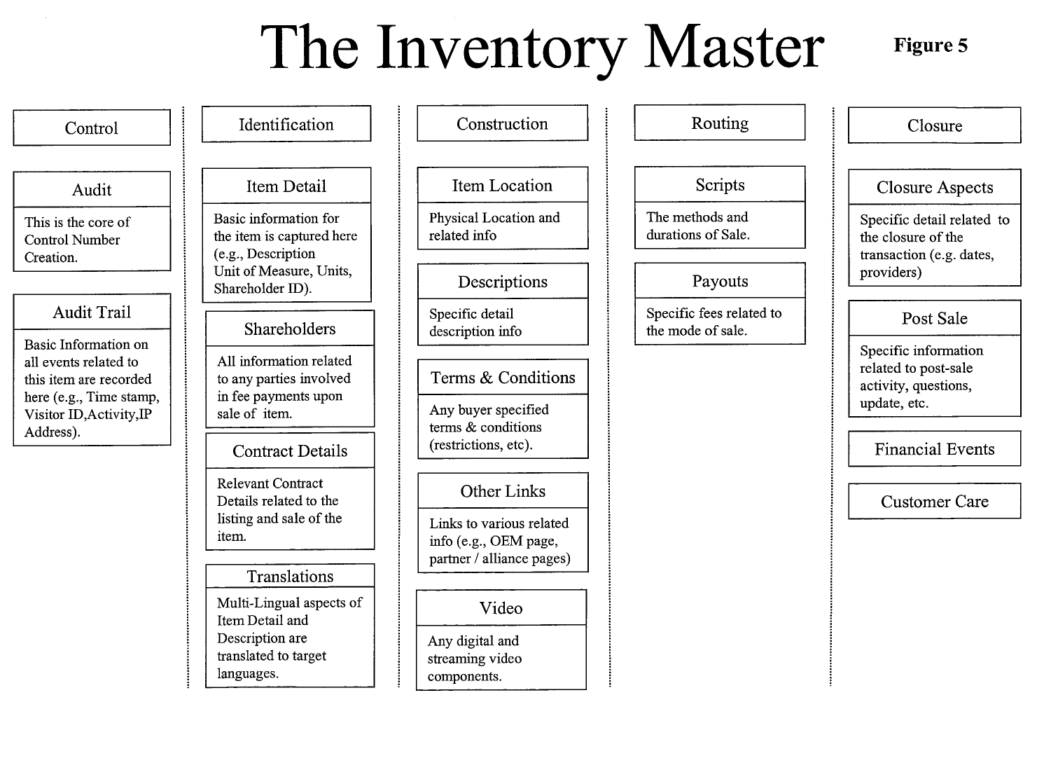

FIG. 6 is a diagram listing asset disposition methods in accordance with preferred embodiments of the invention.

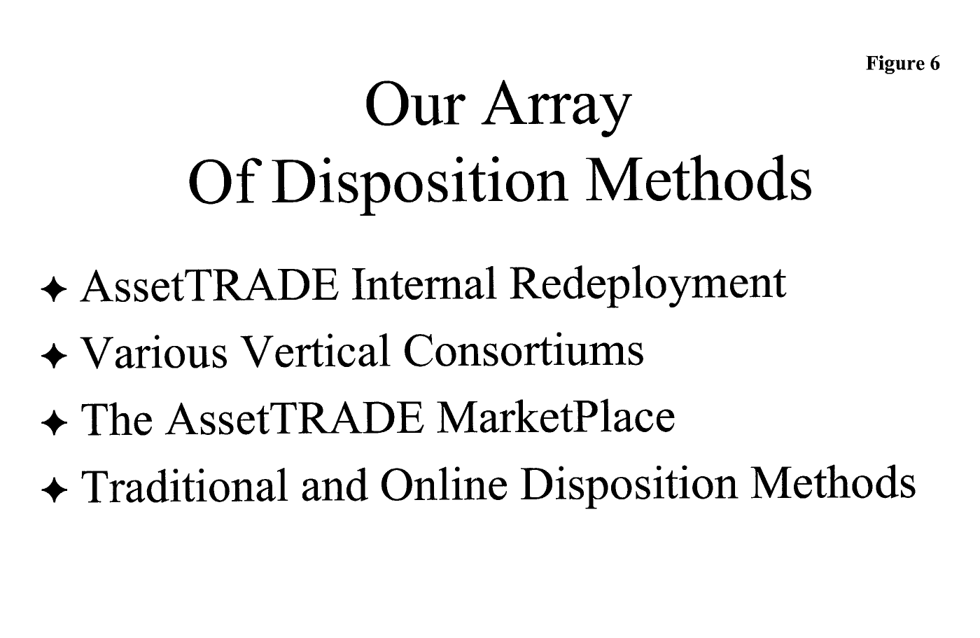

FIG. 7 is a diagram representing the business flow (e.g., flow of assets) in accordance with a preferred embodiment of the present invention.

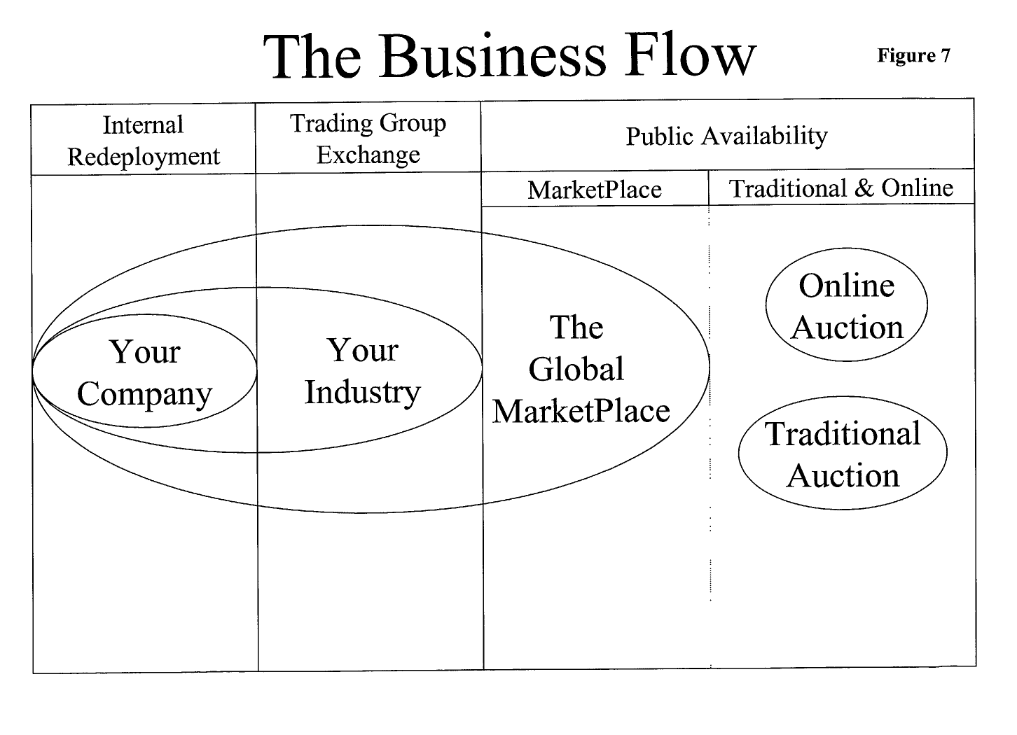

FIG. 8 is a diagram providing an operational overview of a preferred embodiment of the present invention.

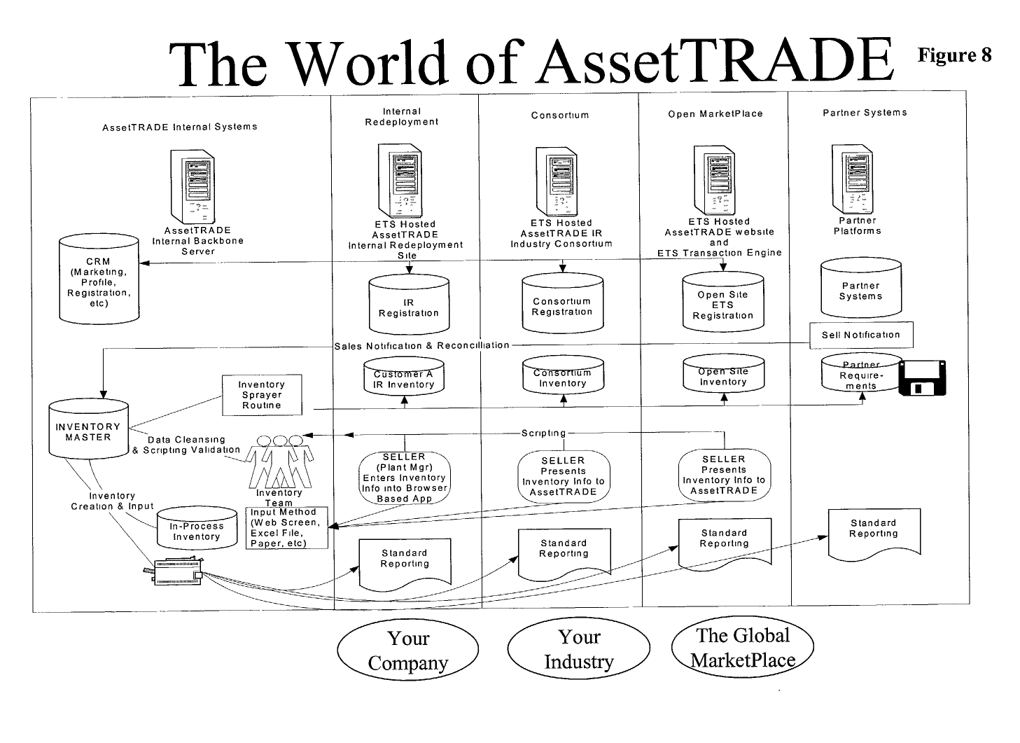

FIG. 9 is a diagram providing an operational overview regarding buyers in accordance with a preferred embodiment of the present invention.

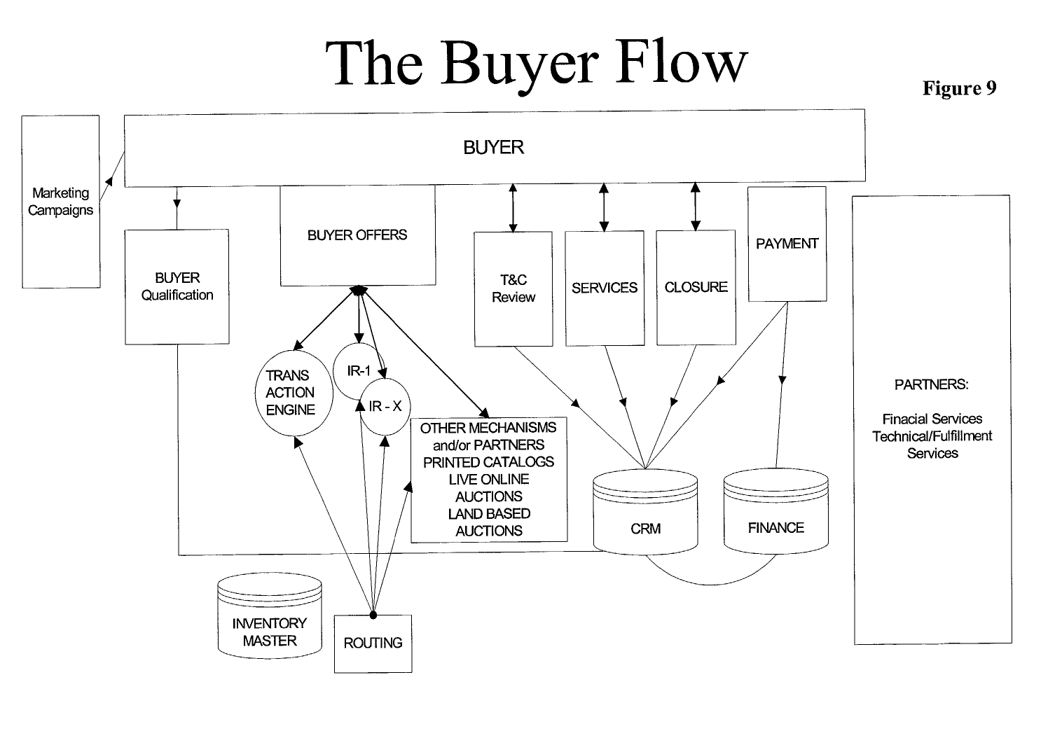

FIG. 10 is a diagram providing an operational overview regarding sellers in accordance with a preferred embodiment of the present invention.

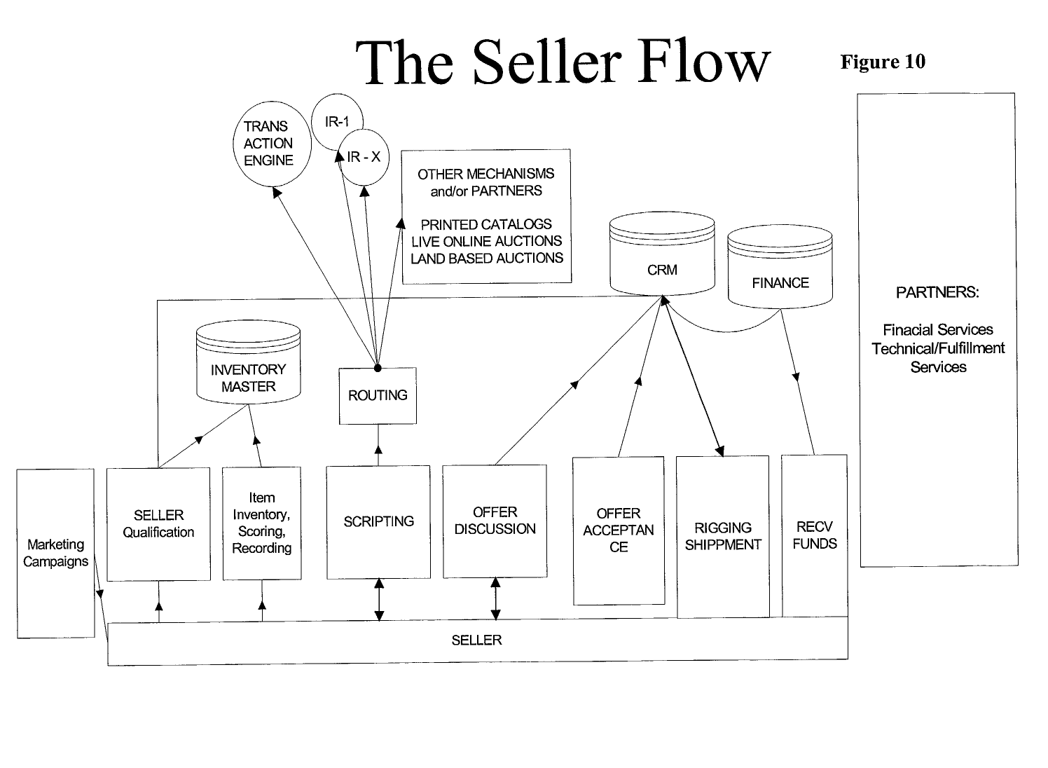

FIG. 11 is another diagram providing an overview of various transactions in accordance with preferred embodiments of the present invention.

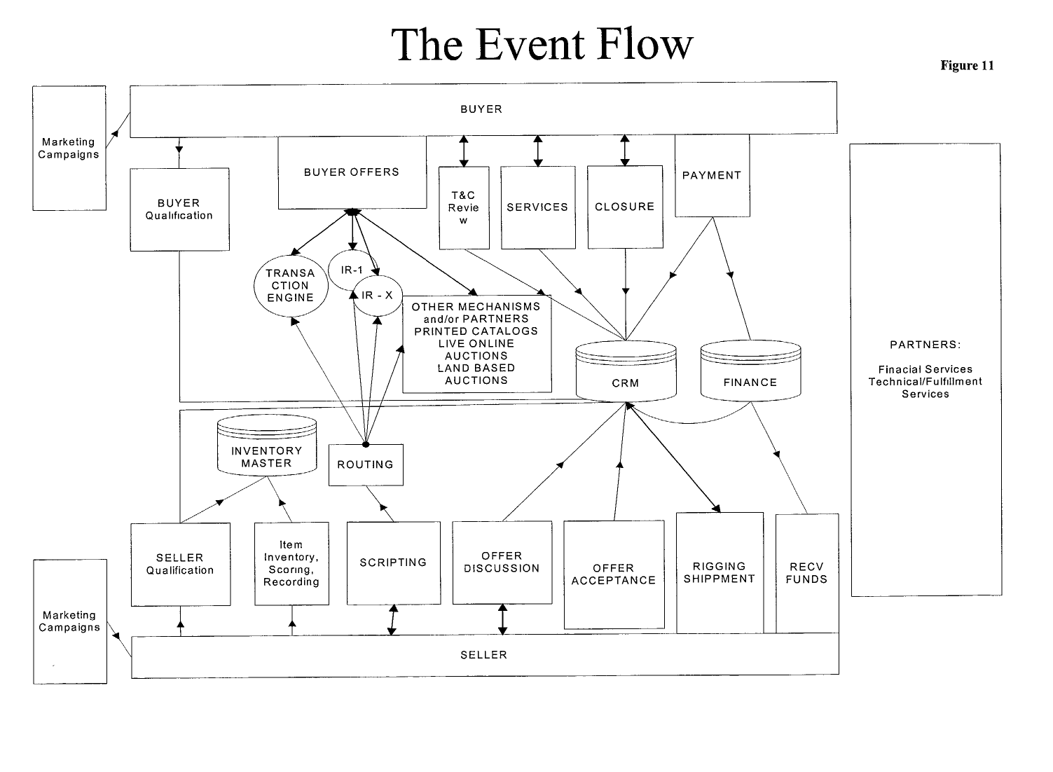

FIG. 12 is a diagram providing an overview of a marketplace in accordance with preferred embodiments of the present invention.

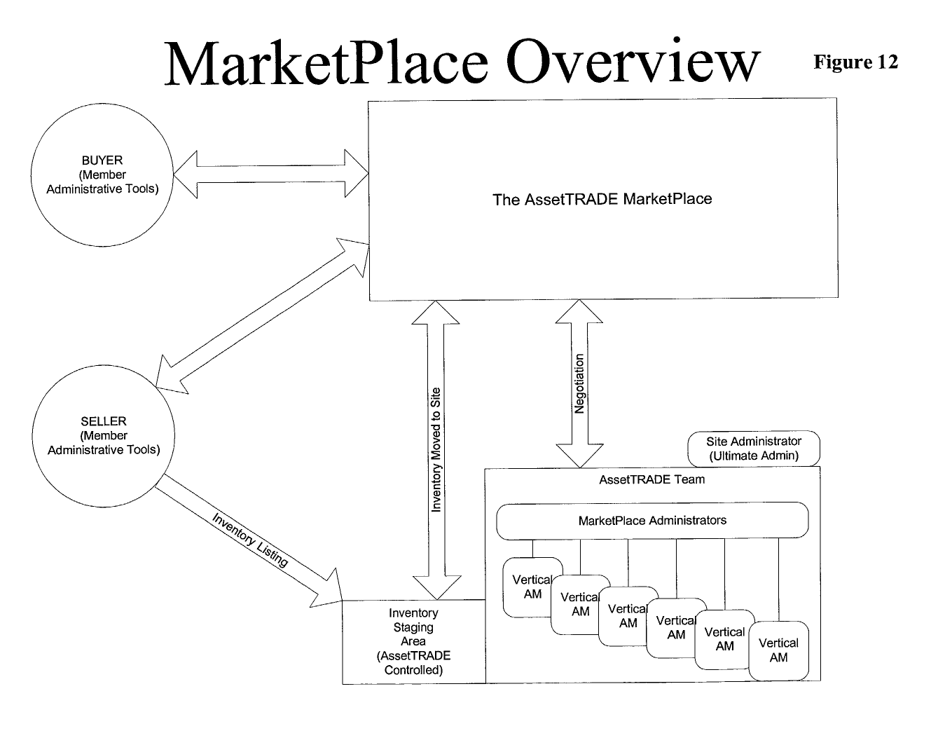

FIG. 13 is a diagram providing an overview of internal redeployment in accordance with preferred embodiments of the present invention.

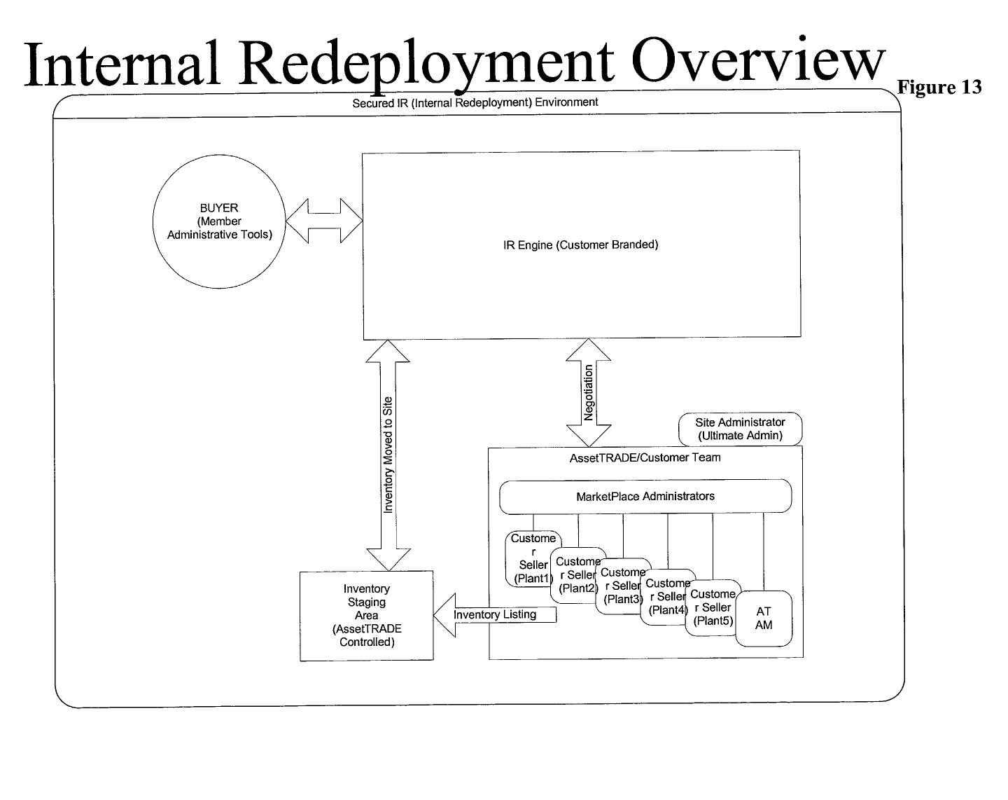

FIG. 14 is a diagram providing an overview of internal redeployment and industry redeployment in accordance with preferred embodiments of the invention.

FIG. 15 is another diagram providing an overview of internal redeployment, industry redeployment and external redistribution in accordance with preferred embodiments of the invention.

### DETAILED DESCRIPTION OF PREFERRED EMBODIMENTS

### Overview

Traditionally, it has been extremely difficult for manufacturing firms to buy and sell used industrial equipment and machinery. Due to the inefficiencies of the market, large manufacturing firms have found that it is much easier to buy new rather than used industrial equipment and machinery. The primary buyers of used equipment and machinery have thus been second and third tier manufacturing firms that buy used equipment from first tier firms. However, the purchase of new equipment and machinery is expensive and typically involves long lead times. This is in contrast to the purchase of used equipment and machinery, which can be purchased immediately. Many large firms are thus evaluating new business models for the purchase of used industrial equipment and machinery. Due to the tremendous growth in the number of businesses using computers connected to the Internet, firms are particularly interested in on-line and, in particular, Internet-based business models.

The present invention provides for novel on-line business methods and systems, and more particularly an Internet-based service for the used industrial equipment and machinery marketplace. The invention employs novel internal redeployment and external redistribution systems, both of which can be accessed by users via the Internet. A client computer connected to the Internet can download digital information from server computers. Client application software typically accepts commands from a user and obtains data and services by sending requests to server applications running on the server computers. A number of protocols are used to exchange commands and data between computers connected to the Internet. These protocols include the File Transfer Protocol (FTP), the Hyper Text Transfer Protocol (HTTP), the Simple Mail Transfer Protocol (SMTP) and the Gopher document protocol.

The HTTP protocol is used to access data on the World Wide Web, often referred to as “the Web.” The Web is an information service on the Internet providing documents and links between documents. It is made up of numerous Web sites located around the world that maintain and distribute electronic documents. A Web site may use one or more Web server computers that store and distribute documents in a number of formats, including the Hyper Text Markup Language (HTML). An HTML document contains text and metadata (commands providing formatting information), as well as embedded links that reference other data or documents. The referenced documents may represent text, graphics, or video. A Web browser is a client application or an integrated operating system utility that communicates with server computers via FTP, HTTP and Gopher protocols. Web browsers receive electronic documents from the network and present them to a user.

The present invention is most suited, but not limited to, uses in connection with the Internet. For example, the present invention may be used in connection with a local area network (LAN), wide area network (WAN) or an Intranet. The present invention is not limited to any particular client or server technology, such as a particular browser, Web server, or operating system.

The on-line market maker service of the present invention provides for novel business methods and systems for the used industrial equipment and machinery marketplace. The invention provides for several distinct advantages through the use of novel on-line internal redeployment systems as well as on-line and off-line external asset disposition systems. Addressing a primary cause of the inefficiencies of the used industrial equipment and machinery marketplace, the market maker service of the present invention provides users with end-to-end service. For purposes of the present invention, the term “user” can be defined as any individual or entity interacting with the present invention for the potential transfer and/or sale and/or purchase of used industrial equipment and machinery, including sellers and vendors as well as buyers and purchasers. Sellers are provided with a novel system for the internal redeployment of assets globally among internal corporate sites (e.g., manufacturing, inventory, distribution) as well as a multiple channel (i.e., off-line and on-line) system for the marketing and disposition of surplus assets. Buyers' needs are fulfilled through the listing of both assets for sale and assets desired by buyers. The market maker service also facilitates transactions by providing a variety of on-line and off-line services including asset appraisal, evaluation and valuation as well as necessary assurances including warranties, financing, credit lines and other services. Additionally, the market maker service also acts as a transaction clearinghouse for taxes, duties and other costs of doing business, further facilitating transactions.

The market maker service of the present invention also enhances the value of those transactions performed in the used industrial equipment and machinery marketplace. The service assures sellers access to not only traditional off-line acquisition and disposition services, but also novel on-line internal redeployment, direct sales and auction services. The service also provides sellers with an extended audience of active buyers accessing asset information. In addition, the service assures sellers that buyers not only have access to real-time, accurate and complete asset information, but that buyers have been pre-approved or qualified to ensure that they possess the financial and other qualifications necessary for completing transactions. By partnering with leading off-line firms in key vertical or other market segments, the service assures buyers that they are accessing real-time, accurate and complete information from reputable industry participants. Buyers and sellers are also provided with the security necessary for participating in transactions as the service provides for the cataloguing, appraisal and valuation of assets, along with financial services. Market specialists and principals further provide transactional value by increasing market liquidity to both sellers and buyers.

The market maker service of the invention is also advantageous in that it provides the used industrial equipment and machinery marketplace and its participants with reliability and integrity. Sellers are assured that they are dealing with buyers that have been pre-approved or qualified, by financial and/or other criteria, and are thus capable of completing transactions. The service also provides buyers with exclusive asset listings, as well as assurance regarding the quality and value of assets by providing for the independent cataloguing, appraising, evaluation and valuation of assets. Further reliability and integrity is brought to the market as the service acts as an independent transaction clearinghouse for the transfer of finds, accounting and auditing. The market maker service of the invention thus provides for those services necessary for transactions to actually occur, thus providing for a reliable marketplace.

The effectiveness of the market maker service of the invention is further enhanced through exclusive and non-exclusive partnering with market leaders possessing broad market knowledge, client relationships and key business processes in the disposition of used industrial equipment and machinery. These partnerships can provide the market marker service with access to a large number of active sellers and qualified buyers worldwide. These partnerships can also provide the market maker service with access to experts in many asset classes, and in many vertical industries.

The business model underlying the present invention can, of course, be replicated and scaled to create a marketplace in key vertical industries and asset classes. Additionally, these partnerships can provide the market maker service with access to financial, logistical and other services for the facilitation of transactions. Most important, these partnerships provide the service with access to top reputations in the industry. By leveraging its partnerships with market leaders, the market maker service of the invention can become the market leader and establish its position as the global marketplace providing all services to buyers and sellers of used industrial equipment and machinery.

### Description of Internet-Based System

The following provides an operations overview of several aspects of the present invention in accordance with preferred embodiments. As the present invention allows for customizing the look, feel and functionality of a specific system in order to meet specific on-line inventory and asset recovery needs including any brand image requirements, the following description is intended as a generic representation based on needs identified as common among large industrial asset recovery and procurement groups.

The market maker service of the invention provides for novel internal redeployment and external asset disposition via on-line requisition, direct sale, auction and/or e-commerce type capabilities. It is preferred that these capabilities of the invention provide for comprehensive customer and product database management. These on-line capabilities can include an administrative interface through which administrators can completely customize any database containing assets, potential customers, auction format information, site configurations, bidders and successful purchasers, and e-mail specifications. This administrative interface is preferably accessible through a standard Web page interface using secure user authentication features. The secure user authentication features can be administered to provide additional users with varied limits of access. The administrative interface can allow for the ability to manually add, delete and modify assets, or control published and non-published assets such as time-frame and other criteria. The administrative interface can also provide the ability to generate reports and view current status regarding purchasers, bidders and product demographic data.

It is preferred that the on-line capabilities of the invention provide for dynamic Web page content. Through the use of HTML page pre-processing, the invention can provide the ability to update the content of requisition, direct sale and auction Web pages dynamically. The invention is thus provided with greater flexibility in providing real-time information that needs to be retrieved from the many databases involved, for example, with the flow of an auction. Further, the invention provides for the addition of new functionalities to a Web page such as real-time advertising of other available asset auctions or possibly even third party advertising spots. Users can thus become more frequently aware of other aspects of the invention due to the flexible nature of the invention's on-line auction technology. For example, multiple bidders can become more frequently aware of other bids due to the flexible nature of the invention's on-line auction technology.

It is preferred that the on-line capabilities of the invention provide for purchase order entry and inquiry. The invention can provide for full cash register-like functionality fitting all direct sale, auction and e-commerce-type specifications. Such functionality can include itemizing customer orders, applying discounts, totaling orders, billing and purchasing functions, tax collection, freight collection, and purchase order tracking. Complete virtual and physical receipt of purchases can be easily designed and graphically matched according to each user's own receipt and purchase order requirements.

It is preferred that the on-line capabilities of the invention provide for on-line payment transaction processing. The invention can include the ability to provide for an on-line payment processing solution that allows for multiple payment types. Credit cards, by way of example only, can be verified and processed in real-time using industry standard solutions including CyberCash, Verifone, Viacrypt PGP and First Visual. Payments can be customized to the server according to payment type. Payments and transactions can be recorded in the same database as existing asset purchases or a separate database depending on a particular user's requirements. All information can be stored in an encrypted database format to allow bidders to quickly bid on additional auction offerings without re-entering their information. A user database can thus be built over time, creating significant marketing advantages.

It is preferred that the on-line capabilities of the invention provide for an order process shipment management system. Transactions tracked by the virtual cash register capability of the invention can be recorded in existing inventory and purchase order databases. Additionally, the order management system can be customized to automatically update the inventory/shipping database at all distribution/fulfillment facilities. The database servers used for shipping can be different than the servers used for inventory or customer records, thus allowing for the creation of a workflow application that will save money by reducing unnecessary resources. The invention can also allow for customization providing real-time shipment tracking screens for tracking order shipments of commercial courier services. The invention can also provide buyers and administrators first hand information concerning product orders placed. Additional features of the invention can include e-mail notification of shipment processing.

It is preferred that the on-line capabilities of the invention provide for promotions. The invention allows administrators to flag certain auction assets as special promotional items, and to locate such assets in an area outside the normal database. Such promotional assets can be those assets a user wishes to auction quickly. By allowing a user to select a Web page from which promotional assets can be accessed, the invention makes it generally much easier for potential purchasers to find such promotional assets on the site.

It is preferred that the on-line capabilities of the invention provide for e-mail notification. The invention can provide for the ability to notify bidders, potential bidders and potential purchasers about significant events. This notification can be especially significant when such bidders and purchasers are maintaining a passive presence at the site. For example, bidders can automatically receive notices if and when they are outbid on an asset. Bidders may also automatically receive notices when an auction is set to close so that they may return to the site in order to place another bid. Successful purchasers can be immediately notified and provided with confirmation of payment, as well as shipment terms and requirements.

It is preferred that the on-line capabilities of the invention provide users with communication and administration capabilities. The communication capabilities of the present invention can provide users with the ability to send each other messages, including messages via external e-mail. The administration capabilities of the invention can provide users with the ability to correct, revise and update company or personal data and information previously submitted to the system. Users can also review all purchases, sales and account transactions. Users that maintain catalogs or asset or inventory items on the system are provided with the ability to review, add, delete and/or the update information when necessary.

It is preferred that the on-line auction capabilities of the invention provide for the security of users including buyers, bidders and sellers. Based on a user's security system, a user's database maintenance facility can include the option of limiting the availability of specific auctioned assets to selected sellers and/or bidders. This capability can be fully administered through the standard browser interface.

It is preferred that the on-line technology of the present invention provides for a search engine. In one preferred embodiment, for example, the on-line auction technology of the invention includes the MICROSOFT SQL engine. The SQL-based database can also be included as it is specifically geared to “wide area” usage such as the Internet. Microsoft Exchange software can be fully integrated, providing for a strong mail server, with a proven design and track record for heavy usage. This software can also include the Active Server Pages (ASP), placing the software in the unique position of being able to utilize future development of “distributed database records and functions,” with only minor changes in server side scripts. Additionally, incorporated code and search libraries allow for the customization of multiple search indexes and filters according to application requirements. Search features can include powerful search filters for user-friendly data search functions along with flexible multiple keyword entry for fast topic finds and item category lookups.

It is also preferred that the on-line technology of the invention provides for a user browser interface. The user browser interface of the invention can include database product search screens formatted according to, by way of example, auction close times, high bids, asset pricing, availability, and search filter specifications. The user browser interface can provide for retrieved asset review information from other sources, and discount and asset package advertisements. The interface can provide for custom logo presentation screens, as well as visual split screens for orders, products and specials. These and other aspects can be present within certain embodiments of the present invention as described below.

1. Description of an Internal Redeployment System

In one preferred embodiment of the present invention, a client application includes an internal redeployment system for the internal management and redistribution of used industrial equipment and machinery as well as items of inventory. The internal redeployment system can be an on-line system, particularly an Internet-based system, allowing access to pre-assigned internal corporate sites (e.g., manufacturing, inventory, distribution). This system can be a closed-end system, in particular an Intranet type system. This system can allow a client to access, query, order and document corporate asset and inventory transfers globally. The internal redeployment of assets and inventory can occur via requisition, auction and/or other e-commerce type transactions.

The internal redeployment system can provide for the internal redistribution of assets and inventory. Internal redistribution can be provided, by way of example and without limitation, via an internal requisition and/or e-commerce type transactions. In addition, internal redistribution can occur via a direct sale, auction and/or e-commerce type transactions. The system can provide for the consolidated procurement and processing of requisitions and/or e-commerce type transactions between multiple internal corporate locations including corporate operating sites and asset and inventory depot centers. The system can also provide for comprehensive asset and inventory database maintenance, shipping and transaction reconciliation. The system can track equipment and assets internally as they are transferred between corporate operating sites and inventory depot centers.

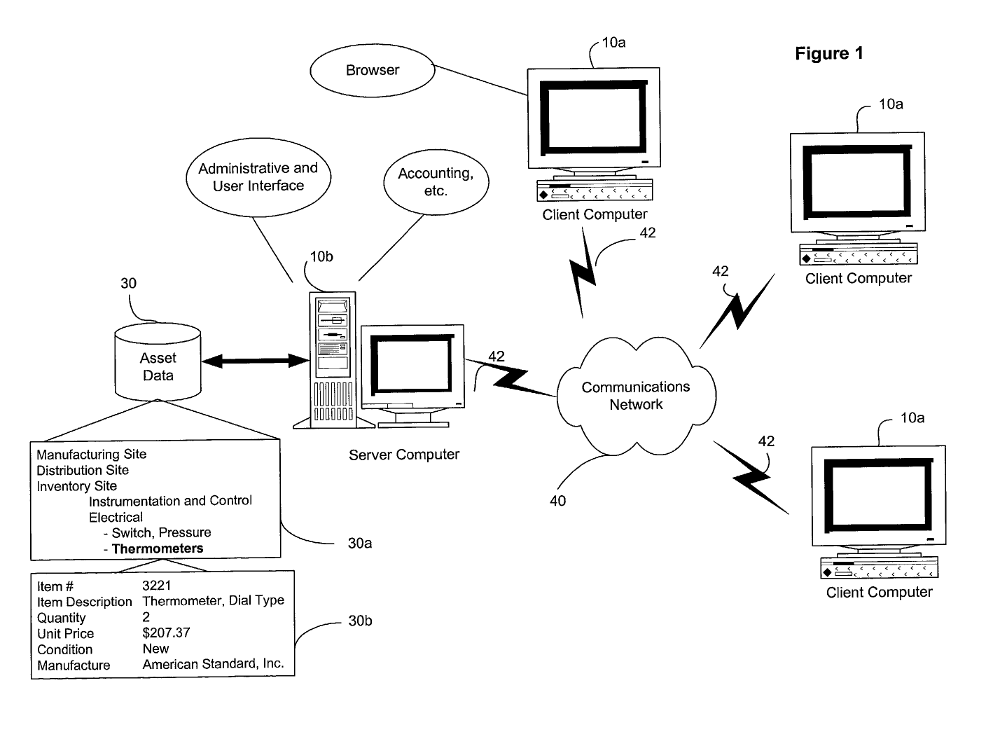

FIG. 1 illustrates an exemplary network environment in which the internal redeployment service of the invention may be employed. Actual network and server environments can, of course, be arranged in a variety of configurations; however, the exemplary environment shown here provides a framework for understanding the type of environment in which the present invention operates. The network can include client computers 10a, a server computer 10b, and database 30 accessible via server computer 10b. The client computers 10a are in electronic communications with the server computer 10b via communications network 40, e.g., an Intranet. Client computers 10a are connected to the communications network 40 by way of communications interfaces 42. Communications interfaces 42 can be any one of the well-known communications interfaces such as Ethernet connections, modem connections, and so on.

Server computer 20b provides management of database 30 by way of server software such as database server system software, described more fully below. As such, server 10b acts as a gatekeeper from a variety of data sources and provides that data to a variety of data consumers. Server computers 10b may maintain data in a relational database. Client computers 10a that desire to access data stored in the database can access the data via communications network 40. In the example wherein server 10b comprises a database server, client computers 10a request the data by way of SQL queries (e.g., update, insert, and delete) on the data stored in database 30.

Where server computers 10b and client computers 10a are connected by way of an Intranet or the Internet, communications may be facilitated by HTML, XML, and so on. Client computers 10a may employ a browser. Client computers 10a may represent asset and inventory depot centers and internal corporate sites including manufacturing, inventory and distribution sites.

The server 10b hosts the internal redeployment service, which is accessible via an Intranet at a plurality of internal corporate sites and asset and inventory depot centers. A central administrator, corporate site or depot center administrator and/or other approved user (e.g., corporate employee, etc.) supplies asset and inventory item data 30 and information including name, description, manufacturer, price and/or other suitable information. Asset and inventory item data 30 and information can be supplied through an administrative interface accessible via a standard Web page. In addition, users can access a user interface via a standard Web page in order to search for and locate a particular asset or item of inventory. Users may search and locate available assets or items of inventory by type, location, industry or other suitable criteria. For example, users can search and locate asset or item of inventory data 30a by corporate site or depot center and asset or inventory type. Users can also access detailed data descriptions 30b regarding a particular asset or item of inventory. Users may request the transfer of an available asset or item of inventory from its current corporate site or depot center to another corporate site or depot center. Where the internal redeployment service is operating on an e-commerce based model, the available asset or item of inventory may have an associated price or reserve, and the user may be required to purchase the available asset or item of inventory via direct sale or auction. The internal redeployment service of the invention can further facilitate such transactions by acting as an internal transaction clearinghouse providing for accounting services as well as the transfer of finds.

The following two models represent alternative exemplary embodiments for locating and redeploying an asset or item of inventory using the internal redeployment system of the present invention. It should be appreciated that a variety of other models are within the scope of the internal redeployment system of the present invention.

Model #1 Internal Redeployment via Requisition

1. User logs onto Internet site and in order to proceed beyond home page, user enters his/her user ID and password.

2. User is routed to a Web page and directed to select an industry category (e.g., utilities, refining and petrochemical, semiconductors, manufacturing).

3. User is routed to a Web page and asked to select asset or inventory type (e.g., valves, generators, electrical).

4. User is routed to a Web page and directed to select an asset or item of inventory (e.g., pressure switch stock #3111). Asset and item of inventory descriptions can also be provided.

5. User is provided with the capability to requisition and user requests at least one asset or item of inventory for transfer to another corporate site or depot center.

Model #2 Internal Redeployment via Direct Sale Purchase

1. User logs onto Internet site and is required to enter ID and password.

2. User is routed to a Web page where user is provided with the capability to enter and user enters search criteria (e.g., stock number, corporate site) for assets and items of inventory.

3. User is routed to a Web page listing assets and items of inventory satisfying the search criteria. Detailed asset and inventory information including price can also be listed.

4. User is provided with the capability to purchase and user purchases at least one asset or item of inventory for transfer to another corporate site or depot center.

With reference to FIG. 1, the internal redeployment system can also provide for the internal management and maintenance of assets and inventory. This system can provide for asset and inventory adjustments (real-time or otherwise) by asset, item of inventory and/or corporate location including assigned corporate site or depot center. This system can also provide for an asset and inventory accounting system for adjusting stock levels and site location availability instantaneously. For example, where an on-line request for transfer (requisition) and/or purchase of an asset or item of inventory has been made, the data 30-30b stored in the server computer 10b can be automatically adjusted to reflect that the asset or item of inventory has been internally redeployed. The data 30-30b can be instantaneously adjusted to reflect that the asset or item of inventory has been transferred from one corporate site to another. The data 30-30b can be adjusted before or after actual shipment of the asset or item of inventory. As another example, the data 30-30b stored in the server computer 10b can reflect those assets and items of inventory located at a corporate location. The data 30-30b can be automatically adjusted to reflect changes (increase or decreases) in items of inventory, whether through sales, internal redeployment or otherwise. The system can also provide for the automatic readjustment of inventory levels via internal redeployment, external purchase or otherwise, where levels fall below or rise above a set level.

The internal redeployment system of the present invention can also be integrated with the external redistribution system of the present invention. The system provides the central administrator, corporate site or depot center administrator or other approved user the opportunity to redistribute assets and inventory via the external redistribution capabilities of the invention. In one embodiment of the present invention, the central administrator can elect to redistribute assets externally via on-line direct sale, auction and/or other e-commerce type transaction. It is preferred that assets and items of inventory available internally can be made available to others via the external on-line redistribution capabilities of the invention. It is further preferred that assets and items of inventory as well as detailed information be made available to others through a Web page accessible via the Internet. More preferred is that the assets and inventory are equally available through the internal redeployment and external redistribution capabilities of the present invention.

2. Description of an Industry Redeployment System

In preferred embodiments, the present invention provides for a client application including an industry redeployment system for the management and redistribution of used industrial equipment and machinery as well as inventory within a consortium or other trading group. For purposes of the present invention, a consortium or trading group may be considered to include participants within a particular industry, industries and/or other approved group. Preferably the industry redeployment system manages and redistributes assets and inventory among participants within a vertical market. The industry redeployment system can be an on-line system, particularly an Internet-based system, allowing access by consortium participants. This system can be a closed-end system, in particular an Intranet type system. This system can allow participants to access, query, order and document asset and inventory transfers within the consortium. The industrial redeployment of assets and inventory can occur via requisition, auction, direct sale and/or other e-commerce type transactions.

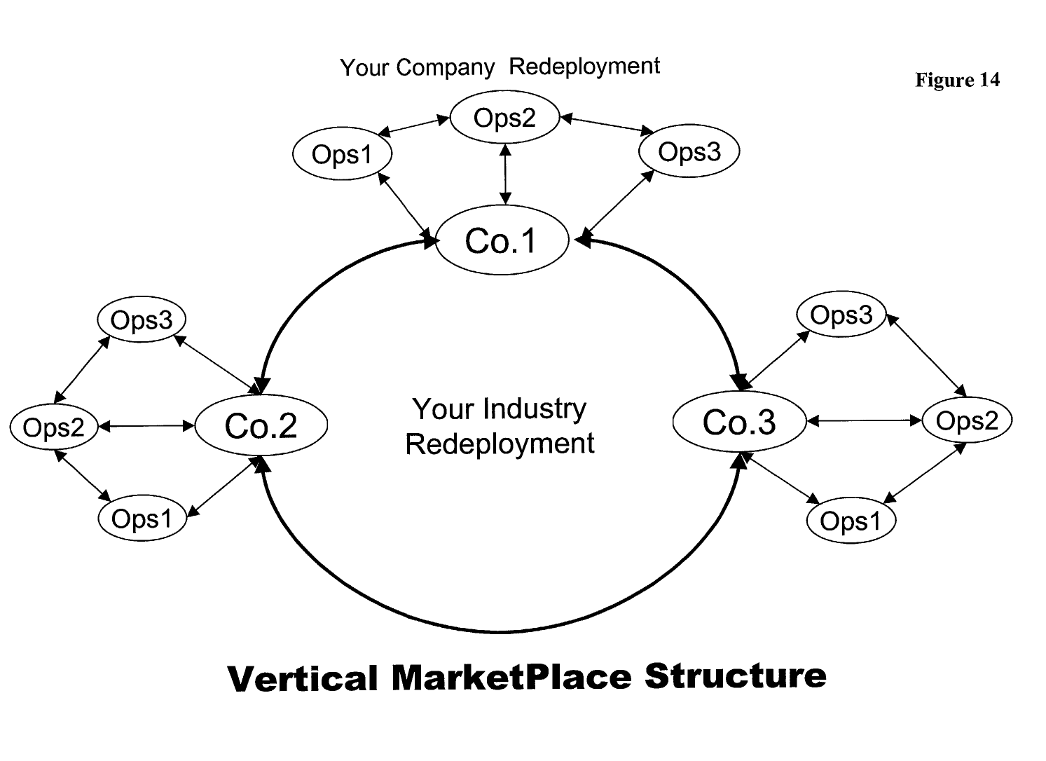

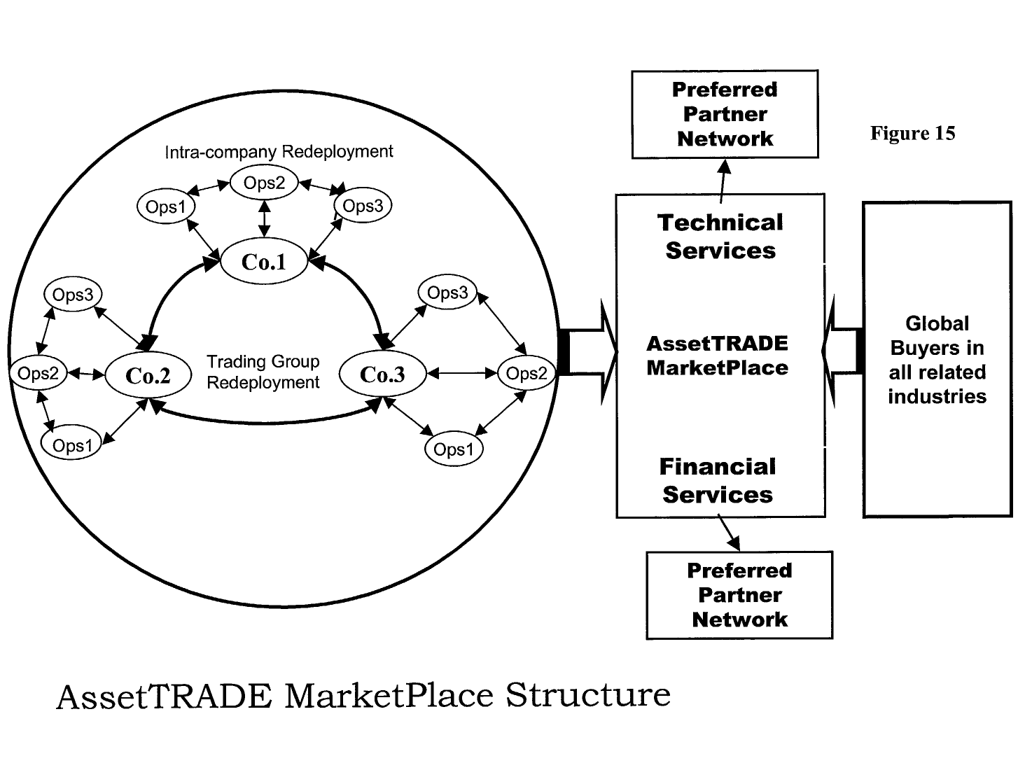

FIGS. 14 and 15 provide an overview of the industrial redeployment system in accordance with preferred embodiments of the invention. The industrial redeployment service provides participants (e.g, Co. 1, Co. 2, Co. 3) or other approved users of a consortium the opportunity to redistribute assets and inventory among themselves. Preferably the consortium participants are part of a particular vertical market. In accordance with preferred embodiments of the present invention, participants within a particular industry, industries and/or other trading group may form a consortium by deciding to redeploy assets and inventory among themselves. In other preferred embodiments, a consortium may be formed where the market maker service determines among which participants assets and inventory may be redeployed.

With reference to FIG. 14 and 15, the industry redeployment system can be integrated with the internal redeployment system of the present invention. In accordance with preferred embodiments, a consortium participant (e.g, Co. 1, Co. 2, Co. 3) has access to the industry redeployment system as well as the internal redeployment system for the redeployment of assets and items of inventory among its multiple internal corporate locations (e.g., Opsl, Ops2, Ops3). With reference to FIG. 15, the industry redeployment system can also be integrated with the external redistribution system of the present invention. In a preferred embodiment of the present invention, assets and inventory are made available for redeployment via the internal redeployment system, and if not redeployed internally, the assets are made available for redeployment via the industry redeployment system, and if not redeployed within the consortium, the assets are made available for external redistribution.

It is further preferred that assets and items of inventory as well as detailed information be made available to consortium participants through a Web page accessible via an Intranet or the Internet. Consortium participants can access detailed data descriptions regarding particular assets or items of inventory. Consortium participants may redeploy and acquire assets and inventory via requisition, auction, direct sale and/or other e-commerce type transactions. In accordance with certain embodiments, the present invention provides for internal communications allowing for continuous contact with all participants throughout any transaction process. Participants can communicate via e-mail, post bulletin board messages, confirm transactions and make numerous other inquiries. Other on-line and off-line support as described herein can also be available.

3. Description of an External Redistribution System

The present invention provides for a client application including on-line transaction capabilities for the external redistribution of used industrial equipment and machinery. Like the internal redeployment system, the external redistribution system is preferably an on-line system, more preferably an Internet-based system, allowing access to registered users. In particular, the external redistribution system provides for the management and disposition of assets and items of inventory via external direct sales, auctions and/or other e-commerce type transactions.

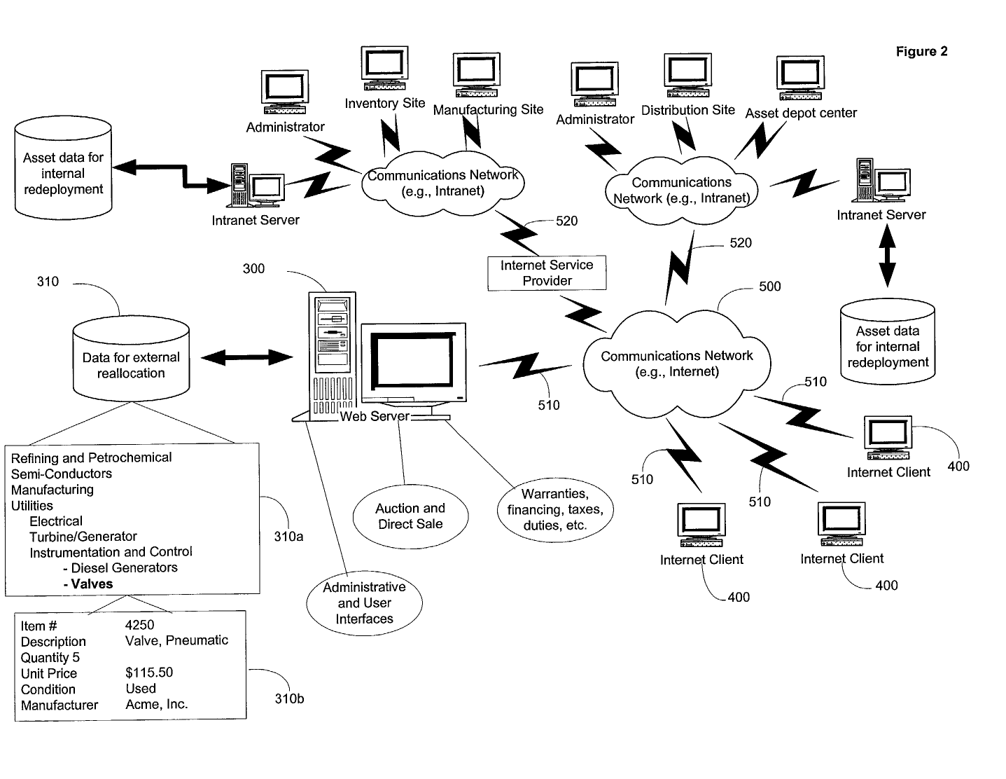

FIG. 2 illustrates an exemplary network environment in which the external redistribution service of the invention may be employed. Actual network and server environments can, of course, be arranged in a variety of configurations; however, the exemplary environment shown here provides a framework for understanding the type of environment in which the present invention operates. The network can include Internet client computers 400, a Web server computer 300, and database 310 accessible via server computer 300. The Internet client computers 400 are in electronic communications with the server computer 300 via communications network 500, e.g., the Internet. Internet client computers 400 are connected to the communications network 500 by way of communications interfaces 510. Communications interfaces 510 can be any one of the well-known communications interfaces such as Ethernet connections, modem connections, and so on. Additionally, a plurality of Intranet-based internal redeployment systems can be integrated with the external redistribution system, as illustrated by FIG. 2. Administrators and users of internal redeployment systems can access the external redistribution system by way of communications interfaces 520. Administrators and users can access the communications network 500 of the external redistribution system via Internet Service Providers (ISP), as illustrated by FIG. 2.

Server computer 300 provides management of database 310 by way of server software such as database server system hardware, described more fully below. As such, server 300 acts as a gatekeeper from a variety of data sources and provides that data to a variety of data consumers. Server computers 300 may maintain data in a relational database. Internet client computers 400 that desire to access data stored in the database can access the data via communications network 500. In the example wherein server 300 comprises a database server, Internet client computers 400 request the data by way of SQL queries (e.g., update, insert, and delete) on the data stored in database 310.

Where server computers 300 and Internet client computers 400 are connected by way of an Intranet or Internet, communications may be facilitated by HTML, XML, and so on. Internet client computers 400 may employ a browser. Internet client computers 400 may represent stations where users can interact with the present invention for the potential transfer and/or sale and/or purchase of used industrial equipment and machinery.

The server 300 hosts the external redistribution system, which is accessible via the Internet at a plurality of Internet client computers, internal corporate sites and asset and inventory depot centers. It is preferred that the external redistribution system provides for the on-line registration, access, qualification and approval of users including both vendors and consumers. It is preferred that access to the system is provided only to registered users. Users are provided with a Web page accessible via the Internet for registering with the external redistribution system of the invention. Users are provided with a Web page including a user input window whereby users are directed to supply (enter or input) certain information in order to register with the system. Such information can include a user's name, address, e-mail address, occupation, credit or financial history and/or any other suitable information. Users are provided with individual user identifiers (IDs) and passwords once registered. It is preferred that users are able to access the system immediately upon registration.

It is preferred that the present invention provides for the on-line qualification and approval of users. While various mechanisms including the telephone are suitable for qualification and approval, users can be provided with a Web page accessible via the Internet for qualification and approval to the system. Users are provided with a Web page including a user input window whereby users are directed to supply certain information for qualification and approval to the system. Information suitable for qualifying or approving potential buyers can include credit or financial check, reference check, industry experience, submission of a deposit or any other suitable information. Although the phrase qualified or approved buyer can have a variety of definitions within the scope of the present invention, within certain embodiments the phrase can be defined as a buyer deemed capable of completing (e.g., financing a purchase) those transactions provided for by the present invention. It is preferred that users are notified via e-mail once qualified and approved.

It is preferred that the present invention provides users with on-line access to the external redistribution system. Users are provided with a Web page accessible via the Internet for accessing the external redistribution capabilities of the invention. Users are provided with the Web page including user input windows whereby users are directed to supply certain information in order to access the system. This information can include, by way of example, user IDs and passwords. It is preferred that all access within the system is protected through SSL and security encryption.

It is preferred that the on-line direct sale capabilities of the invention include extensive asset listing capabilities. Asset and inventory item data 310 and information can be supplied through an administrative interface accessible via a standard Web page. Users can elect to list assets and items of inventory in on-line catalogs, whether by industry, asset type, asset name and/or any other suitable designation. It is preferred that catalog listings include asset categories and sub-categories. In the context of the used industrial equipment and machinery, categories can include utilities, semi-conductors, manufacturing, refining and petrochemical and industrial parts and equipment. It is also preferred that the present invention provides for administration capabilities enabling users including vendors to administer information regarding itself and its respective on-line asset and inventory catalogs. These administrative tasks can be assigned to numerous individuals within an organization. This self- and catalog-administration can be accomplished through an intuitive form action that requires little training. Data and information including asset and inventory descriptions, quantity, price, bid duration, product information, non-public sales as well as tracking information can be easily specified. The capacity to support images can also be included. In accordance with certain embodiments of the invention, a simple interface prompts for image upload after the entry of asset, inventory and/or product data. Catalog entries can be reviewed prior to final submission to the system's database. Catalog entries can also be added and available for bid instantly or require site administrator approval before going public. Additionally, single or multiple vendor (or inter-departmental, multiple vendor) account setup and access can be either pre-approved or require site administrator approval before allowing items to be actively added to the on-line catalog.

It is preferred that users are provided with powerful search capabilities. Users can access a user interface via a standard Web page in order to search for and locate a particular asset or item of inventory. Users may search and locate available assets or items of inventory by industry, type, location or other suitable criteria. With reference to FIG. 2, for example, users can search and locate asset or item of inventory data 310a by industry, asset or inventory category, and asset or inventory type. Users can also access detailed data descriptions 310b regarding a particular asset or item of inventory. These capabilities can be customized to allow for specific or intuitive search inquiries. Users are provided with access to on-line products and a complete array of services and functionalities. In accordance with certain embodiments, the present invention provides for an internal communications center allowing for continuous contact with all registered users throughout any transaction process. Users can communicate via e-mail, post bulletin board messages to groups, confirm transactions, contact vendors and make numerous other inquiries. Additionally, a help system offers both an on-line tutorial and built-in help section to assist with the full cycle operations of the system. Off-line support can also be available.

a. On-line Direct Sales

In accordance with certain embodiments, users including vendors can elect to redistribute corporate assets and inventory via the on-line direct sale capabilities of the present invention. Users can access these on-line direct sale capabilities for the redistribution of surplus assets and inventory as well as increasing revenues from standard product lines. The on-line direct sale capabilities can provide for an Internet interface for multiple users including sellers and vendors to redistribute assets. A payment security system can be provided, as well as seller and buyer notification via e-mail. It is preferred that the invention provides for the comprehensive identification, evaluation, appraisal and valuation of used industrial equipment and machinery.

It is preferred that the on-line direct sale capabilities of the invention provide for Internet-based inventory listings with real-time purchase interaction. It is also preferred that the on-line direct sale capabilities of the invention provide for extensive asset and inventory search capabilities. Users including potential buyers are preferably provided with the ability to search asset and inventory catalogs by industry, asset or inventory type, asset or inventory name or any other suitable search criteria. In one embodiment of the invention, users are provided with general search capabilities across all catalogs. Users can perform asset or inventory searches by key terms including item #, asset description or name, or any other suitable criteria. For example, a client is provided with descriptive information concerning a particular electrical motor in response to the key terms A#4365″ and “electrical motor”.

In another embodiment of the invention, users are provided with the ability to search by catalog. These catalogs may include industry catalogs. Clients are provided with categories and sub-categories of assets and items of inventory in response to the selection of a particular industry catalog. For example, a user is provided with a listing of assets including boilers and steam generators in response to selecting the catalog “utilities”. The user is then provided with a listing of specific boilers in response to selecting the sub-category “boiler”. Finally, the user is provided with descriptive information concerning a boiler in response to selecting a particular boiler.

It is preferred that users can make direct purchases of assets and items of inventory via the on-line place order capabilities of the invention. Assets and items of inventory can be purchased on-line via the submission of user information including user address, as well as billing and shipping information. Preferably it is not necessary to submit such information where the information has been previously submitted. It is preferred that the present invention provides for the facilitation of transactions via the providing of services including, by way of example only, asset warranties, insurance and indemnity services, asset financing, escrow services and foreign exchange. Where an asset or item of inventory is not listed on the service of the present invention, users can submit requests to be notified when such items become available.

The following model represents an exemplary embodiment for searching, locating and redistributing an asset or item of inventory using the on-line direct sale capabilities of the present invention.

Model #3 Direct Sale via Industry Catalog Search

1. User logs onto Internet site and in order to proceed beyond home page user must enter his or her user ID and password.

2. User is provided a Web page displaying the vertical industry catalogs available.

3. User is provided a Web page listing categories and sub-categories of assets in response to selecting an industry catalog.

4. User is provided a Web page displaying detailed asset information in response to selecting a sub-category.

5. User is provided with the opportunity and user enters and electronically submits an offer regarding the asset. Receipt of the offer is immediately acknowledged to the user via e-mail or otherwise.

6. Customer representative contacts the user with any questions and to verify information submitted with offer.

7. Customer representative contacts the user to inform the user of the outcome of the offer. An e-mail or other written confirmation is also sent to the user for written confirmation.

8. Where the offer is accepted, the customer representative assists the user with any details (e.g., financing, shipping, warranties) necessary to complete the direct sale.

9. After determining those services that will be provided, the customer representative provides the user with the total amount of the transaction (e.g., US dollars).

10. The user then releases the appropriate finds to the service.

11. Upon receipt of the finds, the service contacts the seller to coordinate shipping.

It should be appreciated that a variety of other models are within the scope of the present invention.

b. On-line Auctions

In accordance with certain embodiments, users can elect to redistribute surplus assets and items of inventory via the on-line auction capabilities of the present invention. Users can also access these on-line auction capabilities as an alternative channel for increasing revenues from standard product lines. It is preferred that the on-line auction capabilities of the invention include Internet—and Web—based inventory auctions with real-time bid interaction. The on-line auctions capabilities can provide for not only multiple simultaneous auctions, but also multiple auction formats. The on-line auction capabilities can also provide an interface for multiple vendors to auction product. A payment security system can be provided, as well as seller and buyer notification via e-mail. It is preferred that the invention provides for the comprehensive identification, evaluation, appraisal and valuation of used industrial equipment and machinery. Like the direct sale capabilities of the invention, the on-line auction capabilities also provide for comprehensive customer, asset and product database management.

It is preferred that the on-line auction capabilities of the present invention provide for multiple concurrent auctions. An on-line auction administrative interface can be provided which allows for multiple concurrent auctions, thus allowing a particular asset to become available almost universally. The on-line auction capabilities of the invention can accommodate different auction styles and formats, although the standard auction sale format is preferred. With the standard auction sale format, an asset is placed on the online auction block for sale. The highest bidder will be the winner until the entire quantity of the offered asset is gone. Successful bidders are determined with reference to the time of bid receipt. Auction can be conducted absolute to the highest bidder or with minimum reserve prices.

It is preferred that the on-line auction capabilities of the invention include both private and public auction services providing comprehensive asset recovery solutions to clients. Like the direct sale capabilities of the invention, the on-line auction capabilities provide for extensive asset listing and inventory search capabilities with catalog listings readily displayed. It is preferred that users including bidders can easily view current bid status, product information and item specifications once a particular asset or item of inventory catches a user's interest. It is also preferred that each online auction site can be readily customized for a specific audience or marketplace, in particular a specific business to business marketplaces.

It is preferred that the on-line auction capabilities of the invention include complete asset registration and processing systems enabling real-time bidding and purchasing of corporate assets. Bid development and selection can be achieved through automated RFP and RTQ modules. In accordance with the present invention, an exemplary bidding process can be described. Users including bidders are provided with a Web page including an icon, for example a “Bid NOW!” icon, that takes a potential bidder to a bidders form and prompts for action. Using pop down lists and “fill in the blank” form standards, the bidder can enter login, password and bid particulars along with shipping method. Once a bid is placed, the Web page can update immediately to reflect current winning bids. The bidder can be notified via e-mail when the bidder has a closing winning bid or is outbid. Where a bidder is outbid, the bidder may be directed to a “Mybid” Web page where all active bids can be viewed by the bidder. The bidder may, of course, then place another bid via the bidders form. It is preferred that the present invention for product descriptions, current bids and bid actions required that can be easily managed through one consolidated interface. Additionally, the automatic shipment of assets and payment for assets can be provided within these capabilities.

It is preferred that the on-line auction capabilities of the invention provide for comprehensive messaging including the ability to notify clients of on-going bids via e-mail. Banking and accounting features can be customized for transfers through pre-approved third party direct sales or other transfer channels. In addition, customized databases can also be provided for providing historical evaluations, audits and asset management analysis.

The following model represents an exemplary embodiment for searching, locating and redistributing an asset or item of inventory using the on-line auction capabilities of the present invention.

Model #4

1. User logs onto site and in order to proceed beyond home page, user must enter their user ID and password.

2. User is routed to a Web page displaying detailed information for those assets available in the marketplace as well as various purchase methods enabled.

3. User is routed to a Web page hosting an electronic auction in response to selecting a particular asset.

4. An electronic auction commences in which participants make bids (i.e., offers) on the asset over a fixed time frame.

5. User enters and electronically submits a bid to the electronic marketplace. User is provided with a Web page displaying current bids.

6. User is notified electronically when a higher bid has been submitted for the same asset or item of inventory.

7. User again enters and electronically submits a bid to the electronic marketplace. User is again provided with a Web page displaying current bids.

8. User is notified electronically that the bid is a winner.

9. Details (e.g, financing, warranties, shipping) necessary to complete the transaction are determined.

10. User is notified electronically of the total amount of the transaction (e.g., U.S. dollars).

11. User releases the appropriate funds to the service in order to complete the transaction.

12. Upon receipt of the funds, the service contacts the seller to coordinate the user's purchase.

It should be appreciated that a variety of other models are within the scope of the present invention.

3. Description of an Off-Line Remarketing Network

The market maker service of the present invention also provides for off-line remarketing and asset disposition capabilities. These capabilities can include access to the remarketing and asset disposition networks of top international and national asset disposition firms. In particular, these off-line networks are preferably integrated with the internal redeployment and external redistribution systems and methods of the invention. These off-line networks can provide for several advantage within the context of the present invention. First, the off-line networks instantly supply the market maker service with a large number of active and qualified users including buyers and sellers. Second, the off-line networks supply the on-line aspects of the service with experts in a large number of asset classes and vertical industries. Third, the already international presence of the off-line networks helps provide the service with international on-line presence. Finally, and possibly most important, by creating partnerships with top off-line networks, the present invention is provided with a top reputation as well as brand image in the used equipment and machinery marketplace.

It is preferred that the off-line networks of the invention provide for the independent and fair identification, cataloguing, evaluation, appraisal and/or valuation of used industrial equipment and machinery. The on-line asset reallocation aspects of the invention are thus enhanced through the use of independent asset appraisers for evaluating the condition and value of seller and vendor assets. On-line buyers are thus assured they receive assets in the condition as specified and for fair value. Sellers are similarly assured of a fair value for their assets while their chances of asset reallocation enhanced.

It is preferred that the off-line networks provide for maintenance and/or logistical support for used industrial equipment and machinery reallocation. The off-line networks thus provide for outsourced on-site or off-site maintenance and hosting of assets, as well as technical support and training capability. The off-line networks also provide for the physical transport of assets reallocated on-line. Through maintenance and logistical support, the market maker service of the invention is better able to facilitate end-to-end value-driven transactions for the used industrial equipment and machinery marketplace.

It is also preferred that the off-line networks provide for additional off-line asset dispositions. Like the on-line capabilities of the invention, the off-line networks provide for both private and public off-line direct sales and auctions. For example, the off-line networks can provide for resales via private placement, off-line private treaty liquidation, sealed bid auction, open bid public auction, consignment or other similar means. In sum, the off-line remarketing networks facilitate and enhance the on-line capabilities of the invention. Through the integration of on-line and off-line networks, the market marker service of the invention facilitates the selling and buying of used industrial equipment and machinery.

### Conclusion

The present invention provides improved systems and methods of asset management for the reallocation and sales of used industrial equipment and machinery. An important feature of the preferred embodiments of the service is the use of an Internet-or Intranet-based internal redeployment system for the management and redistribution of used industrial equipment and machinery among internal corporate sites. The preferred embodiments of the service also include the use of an Internet-based redistribution system for the external management and disposition of used industrial equipment and machinery via direct sales and auctions. The service thus provides novel systems and methods for the internal redeployment of assets globally among internal corporate sites as well as multiple channel systems and methods for the marketing and disposition of surplus assets. In sum, the service provides for a comprehensive asset database management system for participants in the used industrial equipment and machinery marketplace.

It should be noted that the present invention may be implemented with a variety of database and database management applications and network configurations. The various techniques described herein may be implemented in hardware or software, or a combination of both. Preferably, the techniques are implemented in computer programs executing on programmable computers. Program code is applied to data entered using an input device to perform the functions described above and to generate output information. The output information is applied to one or more output devices. Each program is preferably implemented in a high level procedural or object oriented programming language to communicate with a computer system. However, the programs can be implemented in assembly or machine language, if desired. In any case, the language may be a compiled or interpreted language. Each such computer program is preferably stored on a storage medium or device (e.g., ROM or magnetic diskette) that is readable by a general or special purpose programmable computer for configuring and operating the computer when the storage medium or device is read by the computer to perform the procedures described above. The system may also be considered to be implemented as a computer-readable storage medium, configured with a computer program, where the storage medium so configured causes a computer to operate in a specific and predefined manner.

It is understood, however, that the invention is susceptible to various modifications and alternative constructions. It should be understood that there is no intention to limit the invention to the specific constructions described herein. On the contrary, the invention is intended to cover all modifications, alternative constructions, and equivalents falling within the scope and spirit of the invention.

What is claimed is:

1. A network-based method for the reallocation of assets or items of inventory between and among corporate sites and/or companies, comprising:
providing a first database of assets available for internal redeployed among sites within a first company;
permitting users within the first company to access the first database for the purpose of determining whether such users wish to acquire any of the assets represented therein; and
if an asset represented in the first database is not acquired by a user within the first company, then storing data representative of such asset in a second database which is accessible to users external to the first company, whereby assets of the first company that are not internally redeployed are made available, via a network, for purchase by other companies.

2. A method as recited in claim 1, wherein the method further comprises the use of an internal redeployment model for locating and redeploying an asset or item of inventory, said internal redeployment model comprising:
asking a user to select an industry category from a list on a Web page;
asking the user to select an asset or inventory type;
asking the user to select an asset or item of inventory of the type selected; and
permitting the user to requisition the selected asset or item of inventory, so as to cause the asset or item of inventory to be transferred to a designated corporate site or depot center.

3. A method as recited in claim 1, wherein the method further comprises the use of an internal redeployment model for locating and redeploying an asset or item of inventory, said internal redeployment model comprising:
receiving from a user, via a Web page, search criteria for assets or items of inventory;
providing to the user a listing of assets or items of inventory satisfying the search criteria; and
permitting the user to purchase at least one asset or item of inventory from the list, so as to cause the asset or item of inventory to be transferred to a designated corporate site or depot center.

4. A method as recited in claim 1, wherein said users external to the company are members of a consortium or trading group.

5. A method as recited in claim 4, wherein the method further includes managing and redistributing assets or inventory among participants within a vertical market.

6. A method as recited in claim 1, wherein the method further comprises the use of an external redistribution system providing for the management and disposition of assets or items of inventory via electronic transactions carried out over the Internet.

7. A method as recited in claim 6, wherein said electronic transactions include external, on-line direct sales.

8. A method as recited in claim 6, wherein said direct sales include the use of a direct sale model comprising:
providing to a user a Web page displaying a plurality of vertical industry catalogs;
providing a listing of categories and sub-categories of assets or items of inventory in response to the user having selected an industry catalog;
displaying detailed asset information in response to the user having selected a sub-category;
receiving from the user an electronically-submitted offer regarding the asset, and acknowledging receipt of the offer;
informing the user whether the offer is accepted or rejected; and
if the offer has been accepted, assisting the user with aspects of financing, shipping, and/or warranty necessary to complete the direct sale.

9. A method as recited in claim 6, wherein said electronic transactions include online auctions.

10. A method as recited in claim 9, wherein said on-line auctions include the use of an on-line auction model comprising:
displaying, via a Web page, information concerning assets or items of inventory available;
routing the user to a Web page hosting an electronic auction in response to the user having selected a particular asset or item of inventory;
permitting the user to bid on the particular asset or item of inventory;
when and if the user is deemed to have submitted a winning bid, notifying the user electronically that the user's bid is a winner; and
assisting the user with aspects of financing, shipping, and/or warranty necessary to complete the sale; and

11. A method as recited in claim 6, further comprising providing for on-line qualification and approval of users.

12. A method as recited in claim 1, further comprising the use of an off-line remarketing system.

13. A method as recited in claim 12, wherein said off-line remarketing system is integrated with internal redeployment and external redistribution systems.

14. A network-based system for the reallocation of assets or items of inventory between and among corporate sites and/or companies, comprising:
a first database of assets available for internal redeployed among sites within a first company;
a second database that is accessible to users external to the first company;
computer network means for permitting users within the first company to access the first database for the purpose of determining whether such users wish to acquire any of the assets represented therein, and if an asset represented in the first database is not acquired by a user within the first company, then storing data representative of such asset in the second database, whereby assets of the first company that are not internally redeployed are made available, via a network, for purchase by other companies.
